(19) United States
(12) Patent Application Publication
(10) Pub. No.: US 2014/0181061 A1
(43) Pub. Date: Jun. 26, 2014

(54) DATA DISTRIBUTION IN A CLOUD COMPUTING SYSTEM

(71) Applicants: Hong Jiang, Warren, NJ (US); Raziel Haimi-Cohen, Springfield, NJ (US); Paul A. Wilford, Bernardsville, NJ (US)

(72) Inventors: Hong Jiang, Warren, NJ (US); Raziel Haimi-Cohen, Springfield, NJ (US); Paul A. Wilford, Bernardsville, NJ (US)

(21) Appl. No.: 13/724,090

(22) Filed: Dec. 21, 2012

(51) Int. Cl. G06F 17/30

(52) U.S. Cl. CPC G06F 17/30283
USPC 707/705

(57) ABSTRACT

An illustrative data access management system includes a plurality of data storage devices and at least one data manager device configured to arrange information stored by the data storage devices. The data manager device segments compressive measurements of data into a plurality of subsets. Each of the subsets contains measurement information for facilitating a reconstruction of at least an approximation of the data. The data manager device provides at least a first one of the subsets to a first one of the data storage devices and at least a second one of the subsets to a second one of the data storage devices. One of the data storage devices may be selected, based on at least one criterion, for providing a user access to the at least one subset stored by the selected data storage device.

### TECHNICAL FIELD

This disclosure generally relates to managing data. More particularly, this disclosure relates to devices and methods for distributing data in a cloud computing system.

### DESCRIPTION OF THE RELATED ART

Cloud computing is growing in popularity. A cloud service provider operates one or more data centers to provide computing or data storage services to customers. Data centers may include information or data stored on a server or a data storage device for user access.

While cloud services open up new possibilities for customers and service providers, they introduce new challenges. For example, a server or host machine has a limited capacity and there must be control over data maintained by that server or machine. Additionally, various users require access to data from a potentially wide range of locations. Providing efficient access therefore typically requires duplicating the data stored at a number of different servers so that a user obtains access to stored information from a nearby server. That approach takes up storage capacity at each server with duplicated data, which is not an efficient use of resources.

### SUMMARY

An illustrative data access management system includes a plurality of data storage devices and at least one data manager device configured to arrange information stored by the data storage devices. The data manager device segments compressive measurements of data into a plurality of subsets. Each of the subsets contains measurement information for facilitating a reconstruction of at least an approximation of the data. The data manager device provides at least a first one of the subsets to a first one of the data storage devices and at least a second one of the subsets to a second one of the data storage devices. One of the data storage devices may be selected, based on at least one criterion, for providing a user access to the at least one subset stored by the selected data storage device.

An illustrative method of managing data access includes segmenting compressive measurements of data into a plurality of subsets. Each of the subsets contains measurement information for facilitating a reconstruction of at least an approximation of the data. The method includes providing at least a first one of the subsets to a first data storage device and at least a second one of the subsets to a second data storage device. One of the data storage devices is selected, based on at least one criterion, for providing a user access to the at least one subset stored by the selected data storage device.

Another illustrative method is useful for accessing data stored in a cloud computing system as compressive measurement information that has been segmented into a plurality of subsets. Each of the subsets contains measurement information for facilitating a reconstruction of at least an approximation of the data. The method includes requesting access to the data and obtaining access to at least a first one of the subsets from a data storage device. The data storage device is selected, based on at least one criterion, from among a plurality of data storage devices each having at least one of the subsets. At least one computing function is performed based on the first one of the subsets.

Various embodiments and their features will become apparent to those skilled in the art from the following detailed description of an exemplary embodiment. The drawings that accompany the detailed description can be briefly described as follows.

### BRIEF DESCRIPTION OF THE DRAWINGS

FIG. 1 schematically illustrates an example data management and cloud computing system.

FIG. 2 is a flow chart diagram summarizing an example data storage process useful with an example embodiment.

FIG. 3 is a flow chart diagram summarizing an example data access process useful with an example embodiment.

### DETAILED DESCRIPTION

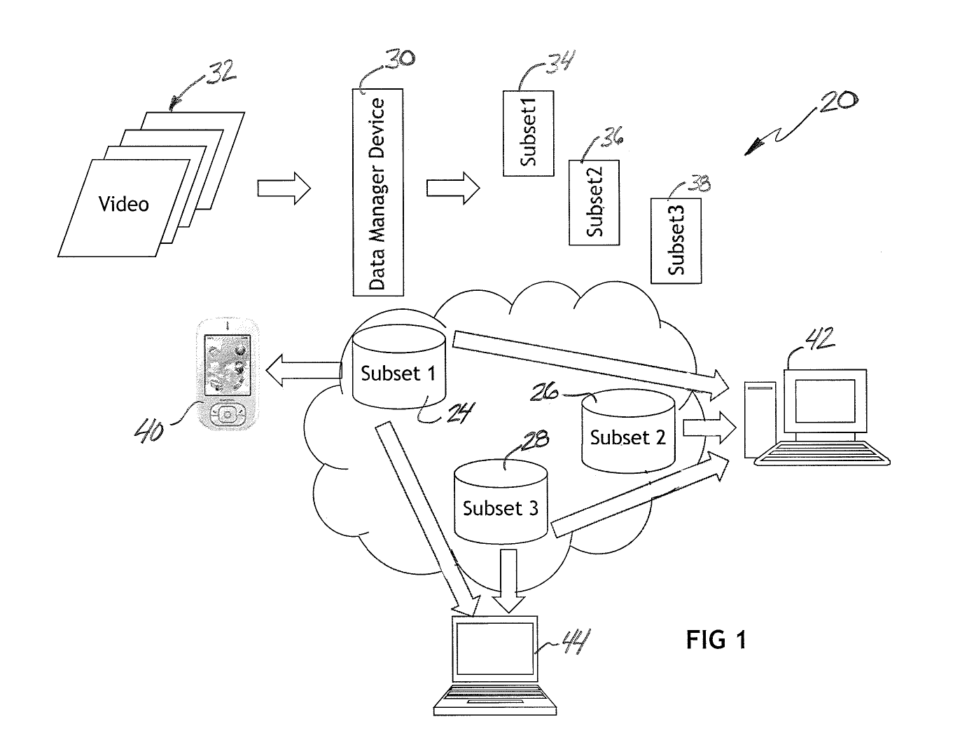

FIG. 1 schematically illustrates a cloud computing system 20 that includes a plurality of data storage devices 24, 26 and 28. A data manager device 30 facilitates storing data 32 in the cloud system 20 in a manner that is useful for providing users access to stored data in an efficient manner. For discussion purposes, the data 32 will be described as video data but embodiments that have features corresponding to those of the disclosed example will be useful for other types of data, such as images, audio or other multimedia data. The data manager device is configured to place data 32 or information corresponding to the data 32 within the data storage devices 24-28 in a way that reduces the amount of resources required to store the data and increases efficiencies for users desiring access to the data through the cloud computing system 20.

As schematically shown in FIG. 1, the data manager device 30 segments compressive measurements of the data 32 into subsets of compressive measurements shown at 34, 36 and 38. Some of the measurements may be included in more than one of the subsets 34-38. Compressive measurements of data may be obtained in one of several known ways. For example, the data manager device 30 in some examples receives the data 32 as compressive measurements from another device. In one such example, a camera or other imaging device generates compressive measurements that correspond to recorded visually perceivable information, such as still video images or moving video, in a known manner.

The data manager device in some examples is configured to generate compressive measurements of the data. In some instances, the data manager device 30 receives the data 32 in another format, such as JPEG or MPEG files. The data manager device 30 generates compressive measurements of the received data and segments the measurements into subsets. One technique for generating compressive measurements of data, such as video data, is described in the published patent application number US2012/0082207. The teachings of that publication are incorporated by reference into this description.

The compressive measurements represent the entirety of the data 32. Each of the subsets in this example includes a sufficient number of compressive measurements that makes it possible to reconstruct data that is an approximation of the original data (e.g., video). Each subset of measurements can be used to analyze the data. Video analysis for object detection, anomaly detection, feature set extraction or other computing tasks based on the video data are possible based on at least one of the subsets 34-38. In many situations, a user will be able to perform a desired computing function or task based on one subset. In some situations where greater accuracy is desired or necessary, more than one subset may be used to obtain the desired results. In general, more subsets provide further information regarding the original data 32 and more accurate results or a higher confidence level in results from processing the reconstructed data.

For example, one subset of compressive measurements for video data may be used to reconstruct a video of certain quality, of certain resolution. The quality and resolution of the reconstructed video may be sufficient for certain applications, such as on a cell phone with small resolution. However, the quality or resolution of the reconstructed video by using the subset may not be sufficient for another application, for example, for display on a very large screen. In this case, more measurements may be obtained by fetching another subset from another server. The combination of measurements from two, or more subsets, makes it possible to reconstruct a video of higher quality and higher resolution to meet the need of the larger screen display.

By combining measurements from a sufficient number of subsets, it is possible to reconstruct the original data with desired precision.

Segmenting the compressive measurements into subsets reduces the storage requirements imposed on the cloud computing system 20 and facilitates more efficient user access to the data. The number of subsets useful for a particular data sample will depend on a variety of factors, such as the amount of data or the level of resolution of the data. Three subsets are shown for discussion purposes but other numbers of subsets will be used in many situations.

The data manager device 30 allocates or provides at least one of the subsets 34-38 to a different one of the data storage devices 24-28. All of the subsets (i.e., all of the measurements) are stored somewhere in the cloud computing system among the various data storage devices in the system. In this example, the data manager device provides or assigns the subset 34 (a first subset) to the data storage device 24, the subset 36 (a second subset) to the data storage device 26 and the subset 38 (a third subset) to the data storage device 26. Each data storage device may also have other subsets associated with other data but only the subsets 34-38 are considered for discussion purposes.

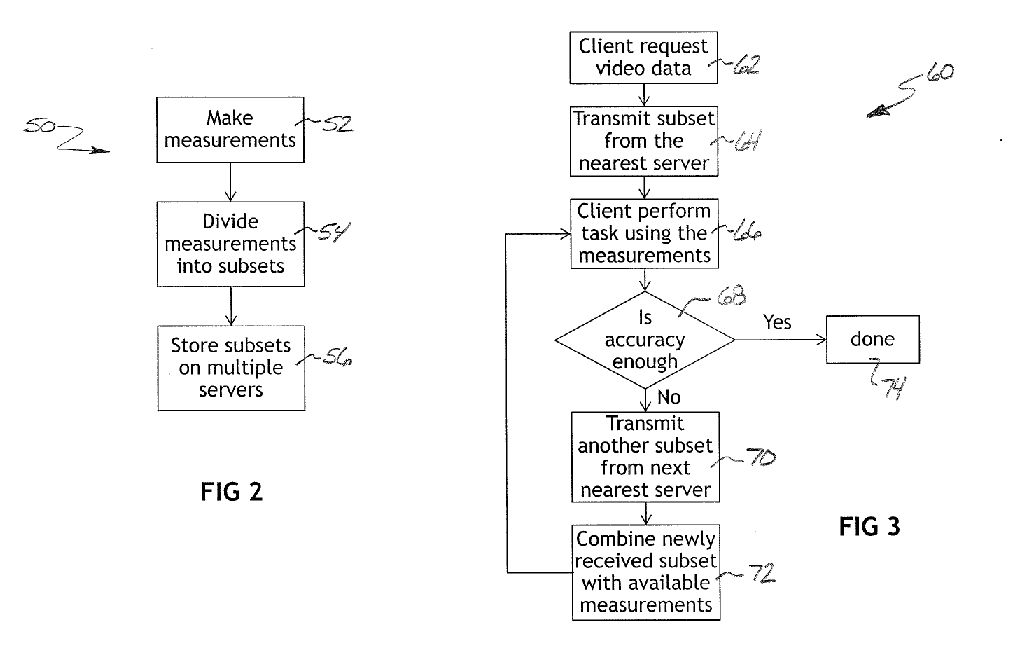

The flowchart diagram 50 of FIG. 2 summarizes one example approach. At 52 compressive measurements of the data are obtained. As mentioned above, in some circumstances the data manager device 30 receives compressive measurements while in others, the data manager device 30 generates the compressive measurements. At 54, the measurements are segmented into subsets (e.g., 24-28 in FIG. 1). At 56, the subsets are each assigned to or provided to a chosen one of the data storage devices (e.g., 34-38 in FIG. 1).

A user desiring access to data through the cloud computing system 20 may make a request through a user device, such as the devices 40, 42 and 44. The data manager device 30 determines which subsets of measurements correspond to the data to which the user desires access. The data manager device 30 determines which of the data storage devices 24-28 can provide access to one of the subsets corresponding to the requested data in a manner that satisfies at least one criterion.

In one example, a data storage device is selected to satisfy a criterion that corresponds to an efficient provision of the data to the user. For example, proximity between the user device (e.g., 40) and a data storage device (e.g., 24) is one example criterion that may indicate whether a particular data storage device would be a good selection. Proximity may be geographic or in network terms (e.g., a number of hops between the devices). Another possible criterion is the data transfer rate available between the user device and each of the candidate data storage devices. The data storage device that is capable of providing data to the user device at the highest transfer rate is selected in some examples. Those skilled in the art that have the benefit of this description will be able to select an appropriate criterion or criteria that will meet their particular needs for determining which data storage device should be selected for providing a subset to the user.

Considering FIG. 3, the flow chart diagram 60 summarizes one example way in which a user obtains access to requested data. At 62, the user requests access to selected data. At 64, one of the data storage devices (e.g., a server) is selected as the provider of the requested data. The user performs a computing task based on the subset of measurements at 66. In some cases, a single subset provides enough information for a desired result of the computing task while in others further measurement information is needed. In the illustrated example, the user (or the user device) makes a determination at 68 whether there is a need for further information. If the accuracy of the result of the computing function based on the single subset provided at 64 is insufficient, another subset of measurement information is provided from another data storage device at 70. The additional subset information is combined with the previously received subset at 72. The user then performs the computing function again at 66. If the result is now satisfactory, as determined at 66, then the process summarized in FIG. 3 ends at 74. If further accuracy is desired, the steps illustrated at 66-72 may be repeated with an additional subset until all subsets corresponding to the requested data have been utilized or a desired result is obtained.

Taking the example of FIG. 1 and assuming that proximity is the primary criterion for selecting an appropriate server, the data storage device 24 will provide the subset 34 to the user device 40 responsive to a request for corresponding data. Assume for the sake of discussion that the first subset received at the user device 40 is sufficient to provide the desired result of the computing function performed based on that subset. This scenario demonstrates how the illustrated arrangement facilitates efficient cloud computing and strategic utilization of the resources within the cloud computing system. The data storage device 24 only had to store the first subset 34 of measurement information rather than having to store the entire data set 32, which saves on memory capacity. The user device was served by a nearby device, which enhances quick and reliable data transfer.

Consider another request from the user device 44. The data storage device 28 is closest so it provides the subset 38 of measurement information to the user device 44. Assume that more information is needed after that subset 38 is used for performing a computing function at the user device 44. The data storage device 24 provides an additional subset to the user device 44. The data storage device 24 may be chosen over the data storage device 26 in such an instance because it has a higher data transfer rate or is closer in proximity to the user device 44.

In the case of the request from the user device 42, the first subset 36 provided by the data storage device 26 and an additional subset 38 from the data storage device 28 are not enough to provide the desired results. The data storage device 24 also provides an additional subset 34. The desired results are obtained based on the combined information from all three subsets in this instance.

As indicated above, additional subsets of measurement information allow for a more accurate or more detailed reconstruction of the data of which the measurements are made. The illustrated arrangement allows a user to obtain a desired level of accuracy and serves the user efficiently without requiring duplication of data at multiple servers.

The example cloud computing system may be realized using a variety of computing devices, such as various combinations of hardware, firmware and software. The data manager device may, for example, be a dedicated computing machine or a portion of a host machine within the cloud computing system. The functions of the example data manager device 30 may be accomplished in a single machine or may be allocated to separate machines. In other words, the example data manager device 30 is schematically shown as a single entity but it may be realized by distinct machines or devices at various locations.

Each of the data storage devices may be realized using a variety of types of equipment. For example, any of the example data storage devices may be a host machine, a portion of a host machine, a server, a portion of a server or computer-accessible memory. While three data storage devices 24, 26 and 28 are shown, there may be a significantly larger number of data storage devices associated with some embodiments.

The preceding description is illustrative rather than limiting in nature. Variations and modifications to the disclosed examples may become apparent to those skilled in the art that do not necessarily depart from the essence of the disclosed embodiments. The scope of legal protection can only be determined by studying the following claims.

We claim:

1. A data access management system, comprising:
a plurality of data storage devices; and
at least one data manager device configured to:
segment compressive measurements of data into a plurality of subsets, wherein each of the subsets contains measurement information for facilitating a reconstruction of at least an approximation of the data;
provide at least a first one of the subsets to a first one of the data storage devices; and
provide at least a second one of the subsets to a second one of the data storage devices;
wherein at least one of the data storage devices may is selected, based on at least one criterion, for providing a user access to the at least one subset stored by the selected data storage device.

2. The system of claim 1, wherein the at least one data manager device is configured to:
receive a user request for access to selected data;
identify which of the data storage devices have the subsets that correspond to the selected data;
determine which of the identified data storage devices satisfies the at least one criterion; and
select the at least one data storage device for providing the user access to the at least one subset.

3. The system of claim 1, wherein the at least one criterion is indicative of efficient access to the data by the user.

4. The system of claim 3, wherein the at least one criterion includes a proximity between the user and the selected data storage device being the same as or less than a proximity between the user and any other of the data storage devices having a subset corresponding to data requested by the user.

5. The system of claim 3, wherein the at least one criterion includes a transfer rate between the selected data storage device and the user being the same as or higher than a transfer rate between the user and any other of the data storage devices having a subset corresponding to data requested by the user.

6. The system of claim 1, wherein the at least one data manager device is configured to
determine whether the user requires additional information regarding the data; and
select an additional one of the data storage devices for providing the user access to the at least one subset stored by the additional one of the data storage devices.

7. The system of claim 1, wherein the at least one data manager device is configured to
receive the data;
make the compressive measurements of the data.

8. A method of managing data access, comprising the steps of:
segmenting compressive measurements of data into a plurality of subsets, wherein each of the subsets contains measurement information for facilitating a reconstruction of at least an approximation of the data;
providing at least a first one of the subsets to a first data storage device;
providing at least a second one of the subsets to a second data storage device; and
selecting at least one of the data storage devices, based on at least one criterion, for providing a user access to the at least one subset stored by the selected data storage device.

9. The method of claim 8, comprising
receiving a user request for access to selected data;
identifying which of the data storage devices have the subsets that correspond to the selected data; and
determining which of the identified data storage devices satisfies the at least one criterion.

10. The method of claim 8, wherein the at least one criterion is indicative of efficient access to the data by the user.

11. The method of claim 10, wherein the at least one criterion includes a proximity between the user and the selected data storage device being the same as or less than a proximity between the user and any other of the data storage devices having a subset corresponding to data requested by the user.

12. The method of claim 10, wherein the at least one criterion includes a transfer rate between the selected data storage device and the user being the same as or higher than a transfer rate between the user and any other of the data storage devices having a subset corresponding to data requested by the user.

13. The method of claim 8, comprising
determining whether the user requires additional information regarding the data; and
selecting an additional one of the data storage devices for providing the user access to the at least one subset stored by the additional one of the data storage devices.

14. The method of claim 8, comprising
receiving the data; and
making the compressive measurements of the data.

15. A method of accessing data stored in a cloud computing system as compressive measurement information that has been segmented into a plurality of subsets, wherein each of the subsets contains measurement information for facilitating a reconstruction of at least an approximation of the data, the method comprising the steps of:
requesting access to the data;
obtaining access to at least a first one of the subsets from a data storage device, wherein the data storage device is selected, based on at least one criterion, from among a plurality of data storage devices each having at least one of the subsets; and
performing at least one computing function based on the first one of the subsets.

16. The method of claim 15, wherein the at least one criterion is indicative of efficient access to the data based on the requested access.

17. The method of claim 16, wherein the at least one criterion includes a proximity between a user device used for the requesting and the selected data storage device being the same as or less than a proximity between the user device and any other of the data storage devices having a subset corresponding to the data requested by the user.

18. The method of claim 16, wherein the at least one criterion includes a transfer rate between the selected data storage device and a user device used for the requesting being the same as or higher than a transfer rate between the user device and any other of the data storage devices having a subset corresponding to data requested by the user.

19. The method of claim 15, comprising
determining that additional information regarding the data is required based on the performed computing function; and
obtaining access to at least a second one of the subsets from an additional one of the data storage devices.

20. The method of claim 19, comprising requesting access to the additional information based on determining that the additional information is required.
